(19) United States
(12) Patent Application Publication
(10) Pub. No.: US 2014/0208057 A1
(43) Pub. Date: Jul. 24, 2014

(54) STORAGE CARD PARTITION SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-GANG YIN, Shenzhen (CN); MENG-LIANG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/968,384

(22) Filed: Aug. 15, 2013

(30) Foreign Application Priority Data
Jan. 22, 2013 (CN) 2013100227896

(51) Int. Cl. G06F 3/06

(52) U.S. Cl. CPC G06F 3/0644
USPC 711/173

(57) ABSTRACT

A storage card partition system and a storage card partition method adapted for a mobile phone are disclosed. The system acquires a storage capacity of a storage card in the mobile phone, defines the quantity of partitions, dividing the storage card into the quantity of partitions according to the storage capacity of the storage card, and defining a capacity of each partition, and names each partition to obtain a partition name and defining a relationship between each partition name and at least one suffix name. The system further acquires a suffix name of a file which will be stored to the storage card or has been stored in the storage card and saves the file, based on its suffix, to a corresponding one of the partitions related to the same suffix.

### BACKGROUND

1. Technical Field

The disclosure relates to mobile phones and, more particularly, to a storage card partition system and a storage card partition method adapted for a mobile phone.

2. Description of Related Art

When a SD card is inserted into a mobile phone, the mobile phone generates a directory which includes folders. A lot of files may be stored in the folder. However, all files are not classified, which results in disorder.

Therefore, what is needed is a storage card partition system to overcome the described shortcoming

### BRIEF DESCRIPTION OF THE DRAWINGS

FIG. 1 is a block diagram of a mobile phone including a storage card partition system in accordance with an exemplary embodiment.

FIG. 2 is a block diagram of the storage card partition system of the mobile phone of FIG. 1.

FIG. 3 is a flowchart illustrating a method of a storage card partition adapted for the mobile phone of FIG. 1.

### DETAILED DESCRIPTION

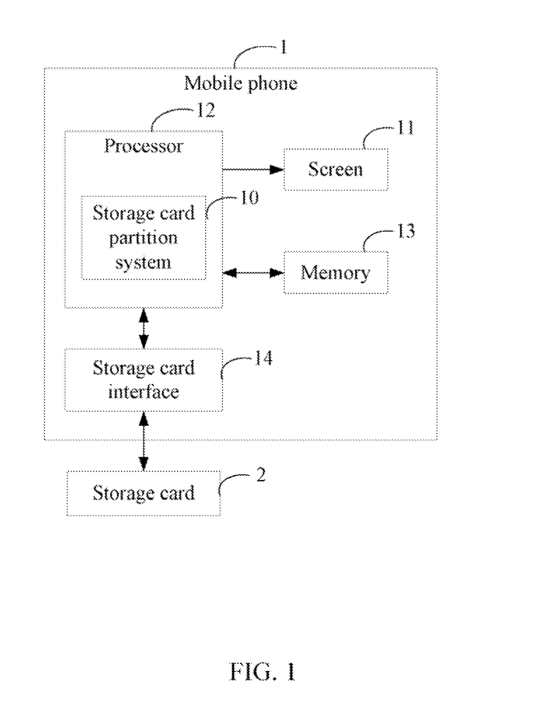

FIG. 1 is a block diagram of a mobile phone including a storage card partition system in accordance with an exemplary embodiment. The mobile phone 1 includes a screen 11, a processor 12, a memory 13, and a storage card interface 14. The storage card interface 14 is connected to a storage card 2 and utilized to recognize the storage card 2. The storage card 2 may be a SD card or a TF card. The storage card 2 is inserted into the storage card interface 14 and includes a preset storage capacity for storing data, such as 8 G or 16 G. The processor 12 controls the mobile phone 1 to work and perform the storage card partition system 10. The memory 13 stores data, such as a phonebook. The screen 11 displays information.

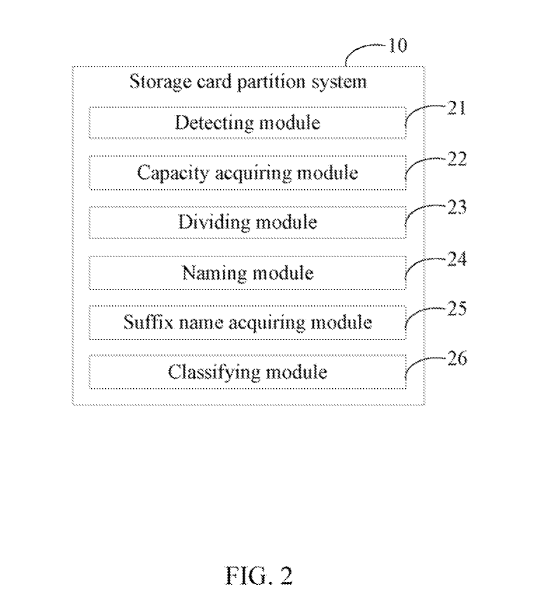

As shown in FIG. 2, the storage card partition system 10 further includes a detecting module 21, a capacity acquiring module 22, a dividing module 23, a nominating module 24, a suffix name acquiring module 25, and a classifying module 26, all of which are collection of software instructions and executed by the processor 12.

The detecting module 21 detects whether or not a storage card 2 is inserted into the mobile phone 1. For example, the detecting module 21 detects whether or not the storage card interface 14 is connected to the storage card 2. When the storage card 2 is inserted into the mobile phone 1, the capacity acquiring module 22 acquires a storage capacity of the storage card 2. In another embodiment, the mobile phone 1 defines a partition mode, the storage card 2 is located in the mobile phone 1, and the mobile phone 1 enters the partition mode in response to user input to actuate the capacity acquiring module 22 to acquire the storage capacity of the storage card 2.

The dividing module 23 defines a quantity of partitions and divides the storage card 2 into the quantity of partitions according to the storage capacity of the storage card 2. In the embodiment, the memory 13 stores a preset formula C=2ⁿ to obtain the quantity, wherein C represents the storage capacity of the storage card 2 and n represents the quantity of partitions. For example, the storage capacity of the storage card 2 is 16 G and the quantity of partitions is four according to the preset rule, that is, the dividing module 23 divides the storage card 2 into four partitions. In another embodiment, the dividing module 23 defines the quantity of partitions on a user interface in response to user input.

The dividing module 23 further defines a capacity of each partition. For example, if the storage card 2 is divided into three partitions and includes a capacity of 8 G, a first partition includes a capacity of 4/3 G, a second partition includes a capacity of 8/3 G, and a third partition includes a capacity of 4 G. In the embodiment, the dividing module 23 defines the capacity of each partition in response to user input.

The naming module 24 names each partition to obtain a partition name. For example, the storage card 2 is divided into four partitions, a first partition is named as a system area, a second partition is named as a multimedia area, a third partition is named as a game area, and a fourth partition is named as a user area. The naming module 24 further defines a relationship between each partition name and at least one suffix name. The suffix name is from a file. For example, the naming module 24 defines a first relationship between the system area and a suffix name “dat” and a second relationship between the user area and suffix names “doc” and “ppt”. In the embodiment, the naming module 24 further defines the relationship between each partition name and at least one suffix name in response to user input.

When a file is stored in the storage card 2, the suffix name acquiring module 25 acquires a suffix name of the file. The classifying module 26 classifies the file to the corresponding partition based on the relationship, that is, saves the file, based on its suffix, to a corresponding one of the partitions related to the same suffix, which results in classification management for the files stored in the storage card 2. In another embodiment, the suffix name acquiring module 25 firstly acquires a file stored in the storage card 2, and then acquires a suffix name of the file.

For example, when a file stored in the mobile phone 1 is copied to the storage card 2, the suffix name acquiring module 25 acquires a suffix name of the file and the classifying module 26 classifies the file to a corresponding partition based on the relationship, that is, saves the file, based on its suffix, to a corresponding one of the partitions related to the same suffix.

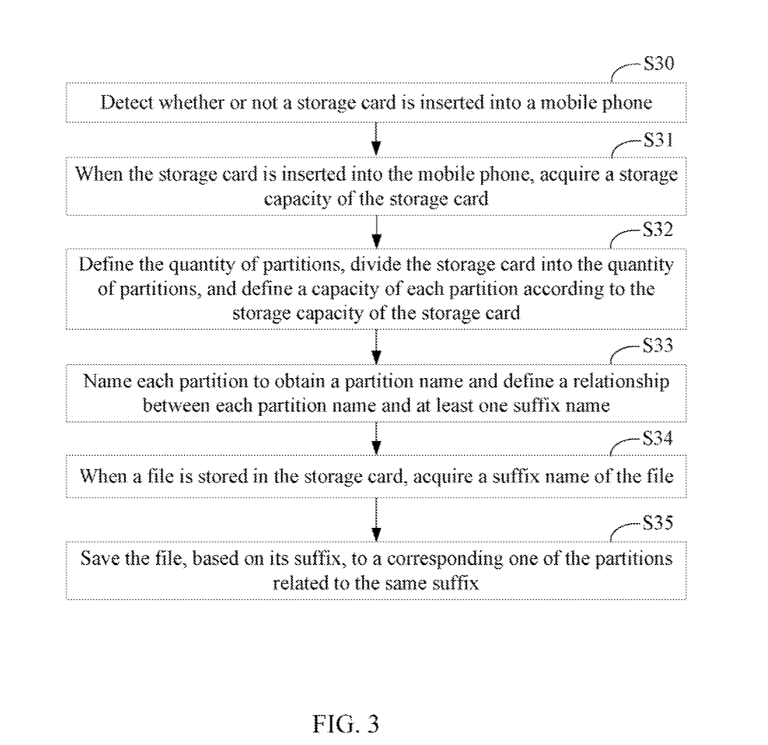

FIG. 3 is a flowchart illustrating a method of adjusting a volume adapted for the mobile phone of FIG. 1. In step S30, the detecting module 21 detects whether or not the storage card 2 is inserted into the mobile phone 1. In step S31, when the storage card 2 is inserted into the mobile phone 1, the capacity acquiring module 22 acquires a storage capacity of the storage card 2.

In step 32, the dividing module 23 defines the quantity of partitions and divides the storage card 2 into the quantity of partitions according to the storage capacity of the storage card 2 and further defines a capacity of each partition. In step 33, the naming module 24 names each partition to obtain a partition name and defines a relationship between each partition name and at least one suffix name. In step 34, when a file is stored in the storage card 2, the suffix name acquiring module 25 acquires a suffix name of the file. In step 35, the classifying module 26 saves the file, based on its suffix, to a corresponding one of the partitions related to the same suffix.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A storage card partition system for a mobile phone, the storage card partition system comprising:
one or more processors; and
a plurality of modules to be executed by the one or more processors, the modules comprising:
a capacity acquiring module to acquire a storage capacity of a storage card in the mobile phone;
a dividing module to define the quantity of partitions, divide the storage card into the quantity of partitions according to the storage capacity of the storage card, and defines a capacity of each partition;
a naming module to name each partition to obtain a partition name and define a relationship between each partition name and at least one suffix name;
a suffix name acquiring module to acquire a suffix name of a file which will be stored to the storage card or has been stored in the storage card; and
a classifying module to save the file, based on its suffix, to a corresponding one of the partitions related to the same suffix.

2. The storage card partition system of claim 1, wherein the dividing module is configured to divide the storage capacity of the storage card according to a preset formula C=2ⁿ to obtain the quantity, where C represents the storage capacity of the storage card and n represents the quantity of partitions.

3. The storage card partition system of claim 1, further comprising a detecting module to detect whether or not a storage card is inserted into the mobile phone, wherein the capacity acquiring module is configured to acquire the storage capacity of the storage card when the storage card is inserted into the mobile phone, and the suffix name acquiring module is configured to acquire the suffix name of the file which will be stored to the storage card.

4. The storage card partition system of claim 1, wherein the mobile phone defines a partition mode, the storage card is located in the mobile phone, and the mobile phone enters the partition mode in response to user input to actuate the capacity acquiring module to acquire the storage capacity of the storage card, and the suffix name acquiring module is firstly configured to acquire a file stored in the storage card, and then acquire the suffix name of the file.

5. A storage card partition method adapted for a mobile phone, the method comprising:
acquiring a storage capacity of a storage card in the mobile phone;
defining the quantity of partitions, dividing the storage card into the quantity of partitions according to the storage capacity of the storage card, and defining a capacity of each partition;
naming each partition to obtain a partition name and defining a relationship between each partition name and at least one suffix name;
acquiring a suffix name of a file which will be stored to the storage card or has been stored in the storage card; and
saving the file, based on its suffix, to a corresponding one of the partitions related to the same suffix.

6. The storage card partition method of claim 5, further comprising:
dividing the storage capacity of the storage card according to a preset formula C=2ⁿ to obtain the quantity, where C represents the storage capacity of the storage card and n represents the quantity of partitions.

7. The storage card partition method of claim 5, further comprising:
detecting whether or not a storage card is inserted into the mobile phone;
when the storage card is inserted into the mobile phone, acquiring the storage capacity of the storage card; and
acquiring the suffix name of the file which will be stored to the storage card.

8. The storage card partition method of claim 5, wherein the mobile phone defines a partition mode and the storage card is located in the mobile phone, the method further comprising:
entering the partition mode in response to user input to acquire the storage capacity of the storage card; and
acquiring a file stored in the storage card and then acquiring the suffix name of the file.

9. A computer-readable storage medium encoded with a computer program, the program comprising instructions that when executed by one or more computers cause the one or more computers to perform operations for partitioning a storage card in a mobile phone, the operations comprising:
acquiring a storage capacity of a storage card in the mobile phone;
defining the quantity of partitions, dividing the storage card into the quantity of partitions according to the storage capacity of the storage card, and defining a capacity of each partition;
naming each partition to obtain a partition name and defining a relationship between each partition name and at least one suffix name;
acquiring a suffix name of a file which will be stored to the storage card or has been stored in the storage card; and
saving the file, based on its suffix, to a corresponding one of the partitions related to the same suffix.

10. The computer-readable storage medium encoded with a computer program of claim 9, the operations further comprising:
dividing the storage capacity of the storage card according to a preset formula C=2ⁿ to obtain the quantity, where C represents the storage capacity of the storage card and n represents the quantity of partitions.

11. The computer-readable storage medium encoded with a computer program of claim 9, the operations further comprising:
detecting whether or not a storage card is inserted into the mobile phone;
when the storage card is inserted into the mobile phone, acquiring the storage capacity of the storage card; and
acquiring the suffix name of the file which will be stored to the storage card.

12. The computer-readable storage medium encoded with a computer program of claim 9, wherein the mobile phone defines a partition mode and the storage card is located in the mobile phone, the operations further comprising:,
entering the partition mode in response to user input to acquire the storage capacity of the storage card; and
acquiring a file stored in the storage card and then acquiring the suffix name of the file.
